(19) United States
(12) Patent Application Publication
(10) Pub. No.: US 2013/0154802 A1
(43) Pub. Date: Jun. 20, 2013

(54) METHOD AND APPARATUS FOR UPDATING A CENTRAL PLAN FOR AN AREA BASED ON A LOCATION OF A PLURALITY OF RADIO FREQUENCY IDENTIFICATION READERS

(71) Applicants: Michael O'Haire, Smithtown, NY (US); Thomas E. Wulff, North Patchogue, NY (US)

(72) Inventors: Michael O'Haire, Smithtown, NY (US); Thomas E. Wulff, North Patchogue, NY (US)

(73) Assignee: SYMBOL TECHNOLOGIES, INC., HOLTSVILLE, NY (US)

(21) Appl. No.: 13/329,383

(22) Filed: Dec. 19, 2011

(51) Int. Cl. G06K 7/01; G01S 15/06

(52) U.S. Cl. 340/10.1; 367/99

(57) ABSTRACT

A method and apparatus updates a central plan for an area based on the location of a plurality of radio frequency identification (RFID) readers by identifying the location of each of the RFID readers using an associated location mechanism. A read zone coverage area for each of the RFID readers is identified. The central plan is updated with the position and the read zone coverage area relative to the position for each of the RFID readers. A status of read zone coverage is determined for the area based on the read zone coverage areas on the central plan for all of the RFID readers in the plurality of RFID readers, wherein a report is provided based on the status of read zone coverage for the area.

### FIELD OF THE DISCLOSURE

The present disclosure relates generally to radio frequency devices and more particularly to updating a central plan for an area based on a location of a plurality of radio frequency identification readers.

### BACKGROUND

Many enterprises are arranged according to a central plan that provides a layout of the goods offered by the enterprise. One type of central plan is a planogram that offers not only layouts of goods, but also provides product information, for example allowing the proprietor to know which items need restocking. Thus, there is a need to update planograms periodically. One manner of updating planograms is to use radio frequency identification (RFID) tags to convey information related to a product. These RFID tags are placed on products and detected by local RFID readers. These RFID readers may be small battery or alternating current (AC) powered readers, that are distributed throughout the enterprise (e.g., large or small stores). A problem that exists is that these RFID readers are small and can easily be mis-placed. Enterprises such as stores are reconfigured from time to time, which could result in moving the RFID readers to new locations within the store. Based on this, the proprietors (e.g., store managers) of these establishments are concerned about loosing RFID readers within their enterprise.

In order to effectively update a central plan for an enterprise (such as a planogram) that employs RFID tags to communicate with RFID readers, it is necessary to be able to locate the RFID readers within the enterprise.

Accordingly, there is a need for a method and apparatus for updating a central plan for an area based on a location of a plurality of radio frequency identification readers.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for updating a central plan in accordance with some embodiments.

FIG. 2 is a flowchart of a method for updating a central plan in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a method and apparatus for updating a central plan for an area by an updating device, wherein the updating is based on a location of a plurality of radio frequency identification (RFID) readers. A method performed by an updating device includes: identifying a location of each of the RFID readers in the plurality of RFID readers, wherein the location of each of the RFID readers is determined using a corresponding location mechanism; identifying a read zone coverage area for each of the RFID readers in the plurality of RFID readers; updating the central plan, using a processing device within the updating device, with the position and the read zone coverage area relative to the position for each of the RFID readers in the plurality of RFID readers; and determining a status of read zone coverage for the area based on the read zone coverage areas on the central plan for all of the RFID readers in the plurality of RFID readers, wherein a report is provided based on the status of read zone coverage for the area.

Further in accordance with the present teachings is an apparatus for updating a planogram for an area based on a location of a plurality of RFID readers. The apparatus includes: a processing device configured to identify a location of each of the RFID readers in the plurality of RFID readers, wherein the location of each of the RFID reader is determined using a corresponding location mechanism; identify a read zone coverage area for each of the RFID readers in the plurality of RFID readers; update the planogram with the position and the read zone coverage area relative to the position for each of the RFID readers in the plurality of RFID readers; generate a report of a status of read zone coverage for the area based on the read zone coverage areas on the planogram for all of the RFID readers in the plurality of RFID readers; and an interface configured to provide the report.

Further in accordance with the present teachings is a non-transient computer readable storage element having computer-readable code stored thereon for programming a computer (also interchangeably referred to herein as a processing device) to perform a method for updating a central plan based on a location of a plurality of radio frequency identification (RFID) readers. The method includes: identifying a location of each of the RFID readers in the plurality of RFID readers; identifying a read zone coverage area for each of the RFID readers in the plurality; updating the central plan with the position and the read zone coverage area relative to the position for each of the RFID readers in the plurality; determining a status of read zone coverage for the area based on the read zone coverage areas on the central plan for all of the RFID readers in the plurality of RFID readers; and generating a report based on the status of read zone coverage for the area.

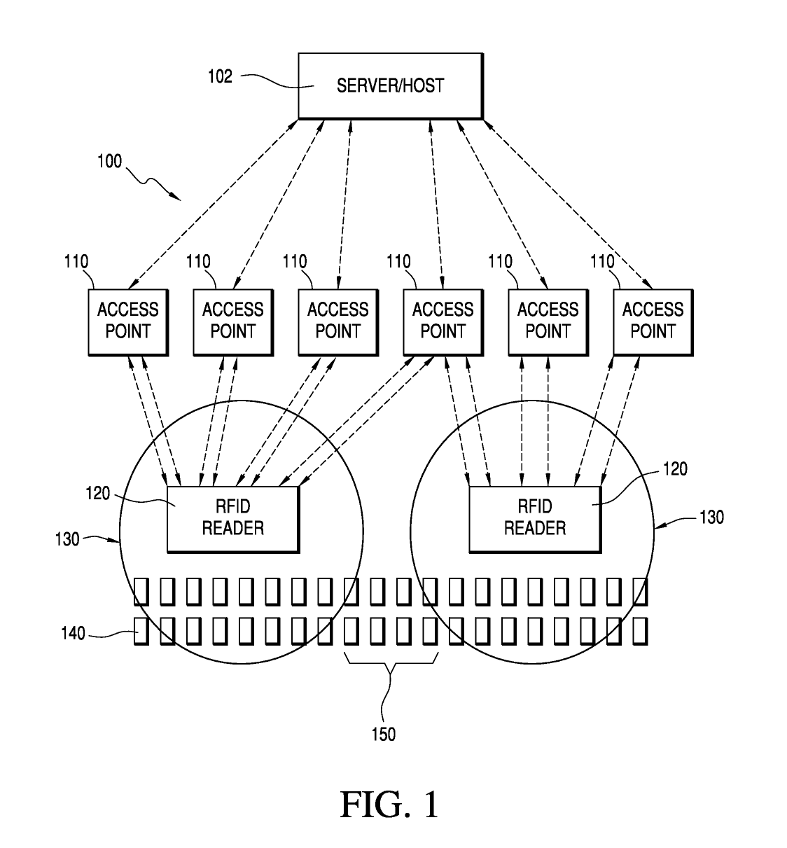

Referring now to the drawings and in particular FIG. 1, a block diagram shows an illustrative system 100, wherein a central plan is updated in accordance with embodiments of the teachings herein. The system 100 includes a server/host 102, a plurality of access points 110, a plurality of RFID readers 120, and a plurality of RFID tags 140. Only a limited number of system elements 102, 110, 120, and 140 are shown for ease of illustration, but additional such elements may be included in the communication system 100. Moreover, other components needed for a commercial embodiment of system 100 are omitted from the drawing for clarity in describing the enclosed embodiments.

In this illustrative implementation, the server/host 102 is a computer system residing within an enterprise. The server/host 102 keeps track of goods (i.e., merchandise, products, etc.) offered by the enterprise by receiving information or data from RFID readers that read RFID tags affixed to the products. The layout of these products within the enterprise is recorded on a central plan, such as a planogram, maintained by the server/host 102. A processing device within the server/host 102 maintains the central plan and, depending on the particular implementation, may be further programmed to update the central plan in accordance with the present teachings. Throughout the present teachings the terms “central plan” and “planogram” may be used interchangeably. Other examples of or names for a central plan include, but are not limited to, a floor plan, a map, an internal plan of a building, etc.

The server/host 102 receives RFID tag data from RFID readers 120 via the access points 110. In addition, the server/host 102 receives information or data from the access points 110 to facilitate functionality in accordance with the present teachings. For example, the server/host 102 receives one or more (i.e., at least one) of RFID reader location information or RFID reader read zone coverage information, to facilitate updating a central plan. Accordingly, the server/host 102 is configured (i.e., adapted) to interface with access points 110 using a hard wired interface or a wireless interface.

The access points 110 are distributed at fixed locations or movable throughout the enterprise to communicate with the RFID readers 120 and to, correspondingly, communicate data to the server/host 102 regarding the RFID readers 120 (e.g., location information) or from the RFID readers (e.g., RFID tag data or location information for the RFID tags or readers). For example, the access points 110 are about 50-60 feet apart. In another example, the access points 110 are 110-120 feet apart. The access points 110 receive RFID tag data wirelessly from the RFID readers 120 using a suitable wireless protocol. The access points 110 and RFID readers 120, thereby, include the needed hardware, e.g., radios or transceivers, to facilitate this wireless communication. In one embodiment, the RFID readers 120 transmit the RFID tag data (and depending on the implementation RFID tag location information) to the access points 110 using a wireless protocol that is based on an Institute of Electrical and Electronics Engineers (IEEE) 802 standard, for example using WiFi™ which is based on the IEEE 802.11 standard or using Zigbee which is based on the IEEE 802.15.4 standard. However, the wireless protocol can be any suitable proprietary or standard wireless protocol.

Moreover, the access points 110 and RFID readers 120 are further configured with a location mechanism (also referred to herein as a location device, not shown) for determining a location of the RFID readers within a given area (e.g., within the entire enterprise or a portion of the enterprise such as a single building of an enterprise). For example, access points 110 can include multiple “locationing” transceivers (i.e., radios) for determining the location of RFID readers 110. Alternatively, access points 110 include a single locationing transceiver, whereby multiple access points 110 are used to determine the location of a single RFID reader 120. In an embodiment, where access points 110 are not used in some or all areas of the enterprise, the server/host 102 is instead configured with the location mechanism that communicates with the location mechanism within the RFID readers 120 to locate one or more RFID readers.

In one illustrative embodiment, the location device or mechanism in the access points 110 and RFID readers 120 uses acoustics, such as ultrasonic technology or some other type of acoustics (e.g., infrasonic, etc.), to locate the RFID readers 120. In one illustrative example, the ultrasonic technology implemented by the location mechanisms in the access points 110 and RFID readers 120 uses trilateration or quadlateration techniques to locate the RFID readers. However, alternative techniques, computations, and measurements may be used or implemented by the location devices within the access points 110 and RFID readers 120 (as described below in additional detail) to determine the location of the RFID readers within a given area.

Where the access point implements an acoustics-based “locationing” algorithm to locate the RFID readers (i.e., the access points determine the location of the RFID readers), the access points listen to chirps (meaning brief audio signals) from the location devices of multiple RFID readers 120. Where the RFID reader implements the acoustics-based locationing algorithm to self-locate (i.e., the RFID readers determine their own location), the RFID reader listens to chirps from the location devices of a single access point having multiple location radios or multiple access points each having a single location radio. A processing device within the access points 110 and the RFID readers 120 is programmed to run the locationing algorithm and control the sending of or listening to chirp signals depending on the particular implementation.

Each RFID reader 120 is further equipped with an internal battery to power the device; and besides the location device for locating the RFID reader, each RFID readers can include a location mechanism for locating RFID tags relative to the RFID readers. Moreover, the RFID readers 120 include hardware (e.g., radios or transceivers) to communicate with (i.e., send interrogation signals to and responsively read) RFID tags 140. RFID tag reading and locating RFID tags is controlled by the processing device within the RFID readers 120. The locating of the RFID tags relative to the RFID readers can be accomplished using multiple techniques. For example, the RFID readers can increase their transmitted power or decrease their transmitted power to adjust the size of their read zones to help identify the location of the RFID tags relative to the RFID readers. Additional techniques include utilizing the time it took to read each tag and/or Return Signal Strength Indicator (RSSI) data to also assist in locating the RFID tags relative to the RFID readers. Moreover, location devices within the RFID readers and tags can implement techniques, such as acoustic or RF techniques, to locate the RFID tags relative to the RFID readers. Supplying the RFID tag data enables enterprises to, for example, restock merchandise on shelves using real-time data, thereby, reducing their out-of-stock inventory, and increasing their overall sales.

In this illustrative embodiment, the RFID readers 120 communicate with the RFID tags 140 using radio frequency waves or energy. The plurality of RFID tags 140 are affixed to products or merchandise and configured to respond to a predetermined range of radio frequency waves from an RFID reader 120. More particularly, the RFID readers 120 transmit information (e.g., an interrogation signal) to an RFID tag 140 by modulating the information onto a radio frequency signal within a particular frequency range. Each RFID reader 120 has a read zone coverage area 130, which is a spatial volume within which effective communication between a RFID reader 120 and RFID tags 140 takes place. In one embodiment, the read zone coverage area 130 is represented by a maximum distance (e.g., radius) from the RFID reader, at which the RFID reader can read data from an RFID tag. Herein, the term read zone, read zone coverage, RFID read zone coverage, read zone coverage area, and coverage area are used interchangeably.

It should be noted that environmental factors such as blockers, reflectors and backscattering techniques as well as other ambient conditions influence the read zones coverage areas 130. The RFID readers may also have provisioning, or set-up parameters that are utilized during their initial deployment to adjust the read zone coverage. These set-up parameters may vary based on where the RFID readers are being deployed, for example based on whether they are deployed on a metal shelf, a wooden shelf, a circular clothes rack. The type of merchandise may also be factored into the set-up parameters. For example, blue jeans, or leather coats may have different set-up parameters. These various set-up parameters vary the size and shape of the associated RFID reader read zones and coverage areas 130.

In an embodiment, the RFID tags 140 are passive meaning that they have no power source. In an alternative embodiment, RFID tags 140 include a power source such as an internal battery. Passive RFID tags 140 receive information and/or energy from a continuous wave radio frequency signal transmitted from the RFID reader 120. The RFID reader 120 receives information from the RFID tags 140 on a reflection of the continuous wave radio frequency signal. More particularly, the RFID tag 140 responds by modulating an information signal on the reflection of the continuous wave radio frequency signal, thereby backscattering the information signal to the RFID reader 120.

In one particular embodiment, EPC Gen 2™ RFID tags are employed by system 100. EPC Gen 2™ RFID tags refer to RFID tags that operate in compliance with the EPC Gen 2 Class 1 Ultra High Frequency (UHF) standard published as amendment 18000-6C (originally in 2006 but including any subsequent revisions) to the International Standards Organization 18000-6 standard RFID interface for item management using devices operating in the 860 MHz-960 MHz Industrial, Scientific, and Medical band. There are numerous types of RFID tags currently existing that can respond to frequency ranges as low as 1.3-13 KHz, and the embodiments disclosed herein envision the RFID tags using both higher and lower frequency ranges.

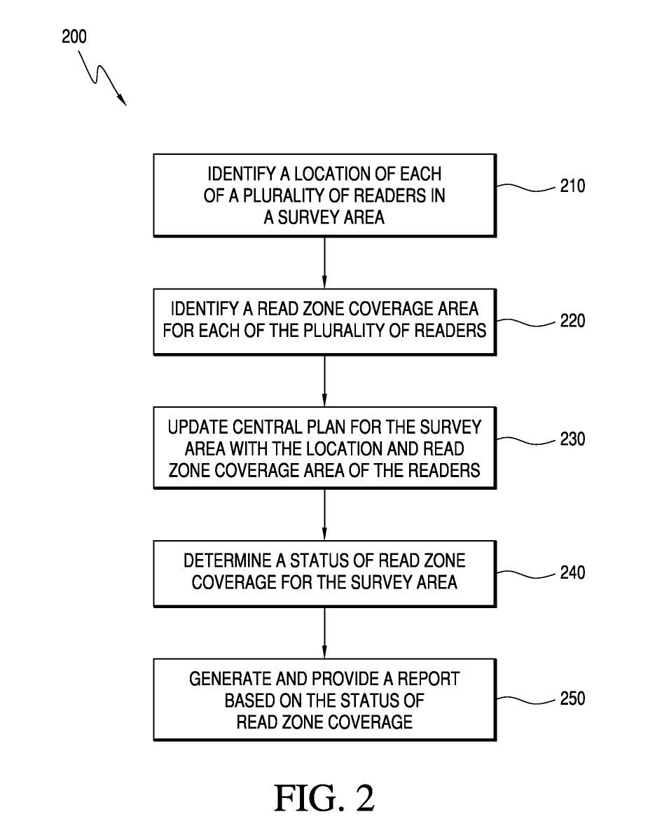

In general, as used herein, server/host 102, access points 110, RFID readers 120, and RFID tags 140 within the system 100 (or their hardware) being “configured” or “adapted” means that such elements are implemented using one or more (although not all elements are shown) memory devices, network interfaces, and/or processing devices that are operatively coupled. These operatively coupled memory devices, network interfaces, and/or processing devices, when programmed, form the means for the corresponding system elements to implement their desired functionality, for example, as illustrated by reference to the method shown in FIG. 2.

The network interfaces (or simply interfaces) are used for passing signals also referred to herein as messaging or signaling (e.g., messages, packets, datagrams, frames, superframes, data signals and the like) containing RFID tag data, location information, read zone coverage area data, or other information between the elements of the system 100. The implementation of the network interface in any particular element depends on the particular type of network, i.e., wired and/or wireless, to which the element is connected and depends on any other devices to which a particular elements directly connects to. For example, some embodiments may contain wireless interfaces, and other embodiments may contain wired interfaces that provide similar functionality.

Where the network and devices support wireless communications, the network interfaces comprise elements including processing, modulating, and transceiver elements that are operable in accordance with any one or more standard or proprietary wireless interfaces, wherein some of the functionality of the processing, modulating, and transceiver elements may be performed by means of the processing device through programmed logic such as software applications or firmware stored on the memory device of the system element or through hardware. Examples of wired interfaces include Ethernet, T1, USB interfaces, etc.

The processing devices utilized by the elements of system 100 may be partially implemented in hardware and, thereby, programmed with software or firmware logic or code for performing functionality described by reference to FIG. 2; and/or the processing devices may be completely implemented in hardware, for example, as a state machine or ASIC (application specific integrated circuit). The memory implemented by these system elements can include short-term and/or long-term storage of various types of information needed for the functioning of the respective elements. The memory may further store software or firmware for programming the processing device with the logic or code needed to perform its functionality.

Turning now to FIG. 2 which shows a flow diagram illustrating a method 200 implemented by a processing device within an updating device in order to update a central plan for an area (also referred to herein as a survey area), in accordance with the teachings herein. In an embodiment, the updating device is located in and integrated solely within the server/host 102. In another embodiment, the updating device is located in and integrated within one or more of the access points 110. In yet another embodiment, the updating device is located in and integrated within one or more of the RFID readers 120. In a further embodiment, the functionality of the updating device is distributed across a combination of at least two of: the server host 102, one or more access points 110, or one or more RFID readers 120. Therefore, depending on the particular system 100 arrangement, each function (i.e., represented by function blocks 210-250) illustrated in FIG. 2 is performed using hardware within the server/host 102, an access point 110, an RFID reader 120, or some combination of these devices.

Method 200 begins at 210 with identifying a location of each of a plurality of RFID readers 120 (ideally all the RFID readers) within an area of an enterprise being surveyed. The location of each RFID reader can be “identified” to the updating device by an external device (e.g., an access device 110 or RFID reader 120) that determines the locations of the RFID readers and reports the locations to the updating device. Alternatively, the updating device “identifies” the location of one or more RFID readers by itself determining the location of the RFID readers.

In an embodiment, prior to identifying the location of the RFID readers 120, these readers are in a sleep state and waiting on a wakeup event. The wakeup event, for instance: is based on a timer event; is based on an outside signal sent to the RFID reader 120 from the server/host 102, an access device 110 or other device; or originates within the RFID reader 120, depending on the embodiment. Once the wake up event occurs, the RFID reader 120 performs an RFID tag inventory and provides the RFID tag data and any location data for the RFID tags for use in updating the central plan. In addition, the location function is performed to determine the location of the RFID readers 120 within the area being surveyed; then the RFID readers 120 transition back to the sleep state. In an embodiment, the RFID readers are periodically awakened and the central plan, thereby, periodically updated using the method 200.

In the embodiment illustrated by reference to FIG. 1, the RFID readers 120 implement a locationing algorithm to self-locate as described below. However, in an alternative embodiment the access points 110 or server/host 102 locate the RFID readers 120. In order to self-locate, the RFID readers 120 use ultrasonic transceivers to discern their distances from multiple other ultrasonic transceivers contained in one or more access points. Accordingly, in this embodiment, the self-locating mechanism of the RFID readers 120 is implemented via acoustics, using ultrasonic technology, for instance, where the ultrasonic technology uses trilateration or quadlateration techniques.

Ultrasonic waves (i.e., sound waves) are much slower (approximately 1 million times slower) than radio frequency (RF) waves. Therefore, more accurate locations can be determined, e.g., to within a square inch of resolution. However, other techniques and measurement can be used to locate the RFID readers. In alternative embodiments, the location of the RFID readers 120 is determined using time difference of arrival computations (e.g., multilateration), triangulation (which uses the measurement of time to determine the distances), radio frequency energy (e.g., using WiFi™ or Zigbee), or light energy, between access points 110 and RFID readers 120. Moreover, measurements of time-of-flight can be measurements of acoustic (including ultrasonic) waves, radio frequency waves or light energy waves. Triangulation may be accomplished using acoustics, radio frequency energy, or light energy. The terms waves and energy are used, herein, interchangeably.

Ultrasonic location techniques facilitate measuring the amount of time it takes from the moment a sound wave is transmitted at the origin to the moment it is received at the destination and, thereby, calculating the distance between the origin and the destination. In the illustrated embodiment, an RFID reader 120 listens for chirp signals (i.e., chirps) from the access point(s). A chirp is an acoustic wave that the RFID reader uses to determine its distance from the sending access point transceiver. As noted above, embodiments are envisioned wherein the chirp originates from either the RFID reader or the access point and is heard by the other. Once several distances are measured, a very accurate geometric model can be calculated, yielding the location of the RFID readers 120 with respect to the access points. If three such distances are determined, the location of the RFID reader is determined using trilateration techniques. If four such distances are determined, the location of the RFID reader is determined using quadlateration techniques. However, more than four distances can used to locate an RFID reader.

Upon locating each of the RFID readers 120 within the survey area, the updating device, at 220, identifies (i.e., receives from an external device or retrieves from a storage device within the updating device) a read zone coverage area for each of the RFID readers. In an embodiment, an RFID reader 120 has knowledge of its read zone coverage area 130, and provides this information to the updating device. Alternatively, the same type of RFID reader is used throughout the survey area, for instance, and the updating device is provisioned with the read zone coverage area of each RFID device. In one illustrative implementation, the read zone coverage area 130 is represented by a ten foot radius. In another example implementation, the read zone coverage area 130 is represented by a radius of about six to eight feet. In yet another illustrative implementation, the read zone coverage area 130 is represented by a radius of about twenty to thirty feet. The size of the radius can be affected by various factors including, but not limited to, the type of RFID technology employed, whether the RFID tags 140 are passive or active, and ambient conditions that can either reflect or redirect the radio frequency signals. Also the shape of the coverage can vary. For example, the shape can be omni-directional, Cardioid shaped, or directionally shaped patterns.

At 230, the updating device updates a central plan for the survey area with the position and the read zone coverage area for each of the RFID readers found within the survey area. For example, their RFID locations are overlaid on an enterprise planogram. Thereafter, the updating device plots out the respective RFID read zone coverage area 130 for each of the RFID readers (at their respective determined locations), which is displayed on the planogram. The updating device examines and analyzes the locations and relative read zone coverage areas plotted on the updated central plan to determine an overall sufficiency of RFID read zone coverage for the survey area. This analysis is also referred to herein as determining (240) a status of read zone coverage for the survey area and assists in understanding the overall coverage that is provided for reading the RFID tags 140.

For example, the status of read zone coverage for the survey may identify gaps (i.e., voids or holes) in read zone coverage, also referred to herein as read zone coverage gaps. Read zone coverage gaps are defined as areas that are not included within a read zone coverage area of any RFID reader. This is undesirable because some RFID tags are not read, leading to an inaccurate merchandise inventory. FIG. 1 illustrates such a read zone coverage gap 150. The status of read zone coverage for the survey area may also identify read zone coverage overlaps (i.e., duplicity) of read zone coverage areas, wherein the read zone coverage areas 130 of multiple (meaning two or more) RFID readers 120 overlap. This may also be undesirable where the overlap is to the extent that it causes an inefficient use of RFID readers. Accordingly, by the updating device determining the status of read zone coverage for a survey area, a number and placement of RFID readers within an enterprise to optimize RFID tag reading can be further determined, which, for instance, minimizes read zone coverage gaps and overlaps.

At 250, the updating device creates (i.e., generates) a report based on the determined status of read zone coverage. The report may detail or identify (among other things) if the RFID read zone coverage is adequate or whether there are read zone coverage gaps or overlays in the survey area. Where there are read zone coverage gaps or overlays, the report may further detail or identify a corrective action to address the read zone coverage gaps or overlays. In one embodiment, such corrective action includes suggestions on placement of additional RFID reader devices or the removal or movement of RFID devices for optimal overall RFID read zone coverage for the survey area. Reports generated may also provide suggestions to modify the planogram, or other type of central plan to create a better read zone coverage volume.

The report is provided using an interface of the updating device. In one embodiment, the interface is a user interface configured to provide the report to a user within system 100, such as a user of the server/host 102. For example, the user interface provides a written report or a visual report via a display on the server/host 102 or a different computer coupled to the server/host 102. In another embodiment, the interface is a network interface configured to provide the report to a remote monitoring device or a remote storage device. For example, the enterprise may store digital copies of all reports for a predefined time period for determining various metrics regarding overall RFID reader coverage for the survey area. In addition, where the access devices 110 or the RFID readers 120 perform central plan updating, these devices can provide the report to the server/host 102.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage element (i.e., medium) having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for updating a central plan for an area by an updating device, wherein the updating is based on a location of a plurality of radio frequency identification (RFID) readers, the method comprising:
identifying a location of each of the RFID readers in the plurality of RFID readers, wherein the location of each of the RFID readers is determined using a location mechanism;
identifying a read zone coverage area for each of the RFID readers in the plurality of RFID readers;
updating the central plan, using a processing device within the updating device, with the position and the read zone coverage area relative to the position for each of the RFID readers in the plurality of RFID readers; and
determining a status of read zone coverage for the area based on the read zone coverage areas on the central plan for all of the RFID readers in the plurality of RFID readers, wherein a report is provided based on the status of read zone coverage for the area.

2. The method of claim 1, wherein the report identifies a read zone coverage corrective action for the area.

3. The method of claim 1, wherein the location of each RFID reader is determined using ultrasonic technology.

4. The method of claim 4, wherein the location of each RFID reader is determined using trilateration or quadlateration techniques.

5. The method of claim 1, wherein the location of each RFID reader is determined using one of: Time Difference of Arrival computations, absolute measurements of time-of-flight, triangulation, radio frequency energy, or light energy.

6. The method of claim 1, wherein the central plan is a planogram.

7. The method of claim 1, wherein the central plan comprises one of: a floor plan; a map or an internal plan of a building.

8. An apparatus for updating a planogram for an area based on a location of a plurality of radio frequency identification (RFID) readers, the apparatus comprising:
a processing device configured to:
identify a location of each of the RFID readers;
identify a read zone coverage area for each of the RFID readers in the plurality of RFID readers;
update the planogram with the position and the read zone coverage area relative to the position for each of the RFID readers in the plurality of RFID readers; and
generate a report of a status of read zone coverage for the area based on the read zone coverage areas on the planogram for all of the RFID readers in the plurality of RFID readers; and
an interface configured to provide the report.

9. The apparatus of claim 8, wherein the interface comprises a user interface configured to provide the report to a user of the apparatus.

10. The apparatus of claim 8, wherein interface comprises a network interface configured to provide the report to a remote monitoring device or to a remote storage device.

11. The apparatus of claim 8, wherein the apparatus further comprises a location device configured to determine the location of at least one of the RFID readers.

12. The apparatus of claim 11, wherein the location device determines the location of the at least one RFID reader using ultrasonic technology.

13. The apparatus of claim 11, wherein the location device determines the location of the at least one RFID reader using one of: Time Difference of Arrival computations, absolute measurements of time-of-flight, triangulation, radio frequency energy, or light energy.

14. A non-transient computer readable storage medium having computer-readable code stored thereon for programming a computer to perform a method for updating a central plan based on a location of a plurality of radio frequency identification (RFID) readers, the method comprising
identifying a location of each of the RFID readers in the plurality of RFID readers;
identifying a read zone coverage area for each of the RFID readers in the plurality;
updating the central plan with the position and the read zone coverage area relative to the position for each of the RFID readers in the plurality;
determining a status of read zone coverage for the area based on the read zone coverage areas on the central plan for all of the RFID readers in the plurality of RFID readers; and
generating a report based on the status of read zone coverage for the area.

15. The computer readable storage medium claim 14, the method further comprising identifying read zone coverage gaps or overlaps for the area, and wherein the report identifies corrective action to address the read zone coverage gaps or overlaps.

16. The computer readable storage medium of claim 14, the method further comprising determining the location of each of the RFID readers using ultrasonic technology.

17. The computer readable storage medium of claim 16, wherein the ultrasonic technology uses trilateration or quadlateration.

18. The computer readable storage medium of claim 14, the method further comprising determining the location of each RFID reader using one of: Time Difference of Arrival computations, absolute measurements of time-of-flight, triangulation, radio frequency energy, or light energy.

19. The computer readable storage medium of claim 13, wherein updating the central plan comprises updating a planogram, a floor plan, a map or an internal plan of a building.
